(19) United States
(12) Patent Application Publication
(10) Pub. No.: US 2007/0081545 A1
(43) Pub. Date: Apr. 12, 2007

(54) Voice over Internet protocol terminal and communication method thereof

(76) Inventor: Pyung-Bin Lim, Suwon-si (KR)

Correspondence Address: Robert E. Bushnell, Suite 300, 1522 K Street, N.W., Washington, DC, 20005-1202, US

(21) Appl. No.: 11/527,677

(22) Filed: Sep. 27, 2006

(30) Foreign Application Priority Data
Oct. 7, 2005 (KR) 10-2005-0094543

(51) Int. Cl. H04L 12/56; H04J 3/16

(52) U.S. Cl. 370/401; 370/466

(57) ABSTRACT

A VoIP terminal including at least one IPv6-based VoIP application and a communication method thereof. The VoIP terminal converts IPv6 address information into an IPv4 address format of a receiving terminal, the IPv6 address information allowing a VoIP application to communicate with the receiving terminal, transmits a first message including the format-converted IPv4 address information to the receiving terminal. The VoIP terminal converts IPv4 address information included in a second message received from a transmitting terminal into the IPv6 address format, and provides the second message including the format-converted address information to the VoIP application of the VoIP terminal.

### CLAIM OF PRIORITY

This application makes reference to, incorporates the same herein, and claims all benefits accruing under 35 U.S.C. §119 from an application for VOICE OVER INTERNET PROTOCOL TERMINAL AND COMMUNICATION METHOD THEREOF earlier filed in the Korean Intellectual Property Office on Oct. 07, 2005 and there duly assigned Serial No. 10-2005-0094543.

### BACKGROUND OF THE INVENTION

1. Field of the Invention

The present invention relates to a Voice over Internet Protocol (VoIP) terminal and a communication method thereof More particularly, the invention relates to a VoIP terminal for communicating with an IPv4 or IPv6 based counterpart VoIP terminal by using only an IPv6 application and a communication method thereof.

2. Description of the Related Art

VoIP refers to Internet telephone technology for a series of equipments that transfer voice information by using IP. VoIP transmits voice information with digitalized discontinuous packets unlike Public Switching Telephone Network (PSTN) using protocols based on circuits.

Such VoIP or Internet telephone technology can advantageously utilize existing IP networks to integrate voice communication services so that telephone users can be provided with long distance and local area calls in Internet and intranet environments.

Signaling protocols for realizing VoIP may include H.323, Session Initiation Protocol (SIP), Media Gateway Protocol (MGCP) and so on. At present, SIP as control protocol for application layer based on simple text is widely used.

However, the Internet Protocol version 4 (IPv4) address system for such VoIP service is being gradually drained owing to rapid growth of users who request VoIP service and other Internet service.

Accordingly, the IPv4 address system is being gradually transferred to the IPv6 address system.

The IP network address system cannot be promptly transferred to the IPv6 address system because of a number of situations including various services set to current Internet environments based on the IPv4 address system, users convenient to the current services and demands from Internet Service Providers (ISPs) who have established the Internet environments based on the IPv4 address system.

This means that the IPv6 address system network should exist together with the IPv4 address system network for a considerable time period.

Therefore, this requires a technology capable of connecting the IPv4 address system network to the IPv6 address system network.

Such connection technologies are being actively applied to connect the IPv4 address system network to the IPv6 address system network.

A connection technology between IPv4 and IPv6 address-based networks will be described briefly about VoIP service.

Following approaches have been proposed for the purpose of communication between an IPv6 address-based VoIP terminal and an IPv4 address-based VoIP terminal.

First, a gateway or translator is established between an IPv4 address-based network and an IPv6 address-based network.

The translator converts the format of an IPv6-based VoIP terminal address (source address) included in an IPv6 VoIP packet header, which will be transmitted from an IPv6-based VoIP terminal to an IPv6-based VoIP terminal, into an IPv4 address, and transmits the format-converted IPv4 address to the IPv4-based VoIP terminal.

The translator converts the format of an IPv4-based VoIP terminal address (source address) included in an IPv4 VoIP packet header, which will be transmitted from the IPv4-based VoIP terminal to the IPv6-based VoIP terminal, into an IPv6 address, and transmits the format-converted IPv6 address to the IPv6-based VoIP terminal.

Second, an IPv4/IPv6 dual stack is equipped in a VoIP terminal.

The VoIP terminal uses an IPv4 stack of the IPv4/IPv6 dual stack to communicate with an IPv4-based VoIP terminal.

The VoIP terminal also uses an IPv6 stack of the IPv4/IPv6 dual stack to communicate with an IPv6-based VoIP terminal.

However, the translator supports only SIP (Session Initiation Protocol) among VoIP protocols but does not support other protocols other than SIP. Other protocols other than SIP may include H.323, proprietary VoIP protocol and so on.

This will be described in more detail.

When the translator supports Session Initiation Protocol-Application Level Gateway (SIP-ALG), it converts the format of IPv4 address information included in a header and a payload of an IPv4 packet, which will be transmitted to an IPv6-based VoIP terminal, into IPv6 address information, and transmits the format-converted address information to the IPv6-based VoIP terminal.

The translator also converts the format of IPv6 address information included in a header and a payload of an IPv6 packet, which will be transmitted to an IPv4-based VoIP terminal, into IPv4 address information, and transmits the format-converted address information to the IPv4-based VoIP terminal.

On the other hand, if the translator does not support H.323 or proprietary VoIP protocol, it may not support ALG for H.323 or proprietary VoIP protocol.

Accordingly, IPv4 and IPv6 based VoIP terminals that conduct communication via H.323 or proprietary VoIP protocol cannot normally communicate with a counterpart VoIP terminal via a translator that does not support H.323 or proprietary VoIP protocol.

Furthermore, where an IPv4/IPv6 dual stack is installed in a VoIP terminal, both of an IPv4 VoIP application and an IPv6 VoIP application are employed in the IPv4/IPv6 dual stack, thereby increasing cost owing to increased memory size as well as complicating installation and operation owing to a dual data base structure in operation.

Herein the memory is a device where an IPv4 VoIP application and an IPv6 VoIP application are operated.

The VoIP terminal using the IPv4/IPv6 dual stack includes a telephone number and IP address of a counterpart VoIP terminal, and has a database according to the address type of the counterpart VoIP terminal.

That is, the VoIP terminal using the IPv4/IPv6 dual stack has a database storing the address and telephone number of a counterpart IPv4-based VoIP terminal and a database storing the address and telephone number of a counterpart IPv6-based VoIP terminal.

### SUMMARY OF THE INVENTION

The present invention has been made to solve the foregoing problems of the prior art and it is therefore an object of the present invention to provide a VoIP terminal for communicating with an IPv4 or IPv6 based VoIP terminal irrespective of the VoIP protocol and a communication method thereof.

It is another object of the present invention to provide a VoIP terminal for communicating with IPv4 or IPv6 based VoIP terminals by using only an IPv6 VoIP application in an IPv4/IPv6 dual stack.

In order to realize the foregoing objects, the invention provides a Voice over Internet Protocol (VoIP) terminal that communicates with at least one terminal by using at least one application based upon a predetermined address format, comprising a message format converter, the message format converter carrying out steps of:

converting a first address information into an address format of a receiving terminal, the first address information allowing an application to communicate with the receiving terminal, and transmitting a first message including the format-converted first address information to the receiving terminal; and

converting a second address information included in a second message received from a transmitting terminal into the predetermined address format, and providing the second message including the format-converted second address information to a counterpart application of the VoIP terminal.

Preferably, the predetermined address format is an IPv6 address format.

The first address information may include at least one of an address of the VoIP terminal and an address of the receiving terminal.

The address of the VoIP terminal may be an IPv6 address format and the address of the receiving terminal may be an IPv4 address format or an IPv6 address format.

The second address information may include at least one of an address of the VoIP terminal and an address of the transmitting terminal.

Furthermore, the address of the transmitting terminal may be an IPv4 address format or an IPv6 address format.

The invention also provides a Voice over Internet Protocol (VoIP) terminal that communicates with at least one terminal of a different address format by using at least one application based upon a predetermined address format, comprising: a header address converter for converting a first address information, which will be included in a first message to be transmitted from a predetermined VoIP application to a receiving terminal, into an address format of the receiving terminal, and converting a second address information included in a header of a second message received from a transmitting terminal into the predetermined address format to provide the format-converted second address information to a VoIP application of the VoIP terminal; and a payload address converter for converting an address information included in a payload of the first message into the address format of the receiving terminal, and converting an address information included in a payload of the second message into the predetermined address format to provide the format-converted address information in the payload of the second message to the VoIP application of the VoIP terminal.

The invention also provides a message transmission method in a Voice over Internet Protocol (VoIP) terminal that communicates with at least one terminal of a different address format by using at least one application based upon a predetermined address format, the method comprising steps of converting an address information into an address format of a receiving terminal, the address information allowing a VoIP application to communicate with the receiving terminal; and transmitting a message including the format-converted address information to the receiving terminal.

Furthermore, the invention provides a message receiving method in a Voice over Internet Protocol (VoIP) terminal that communicates with at least one terminal of a different address format by using at least one VoIP application based upon a predetermined address format, the method comprising steps of: converting an address information included in a message received from a transmitting terminal into the predetermined address format; and providing the message including the format-converted address information to a VoIP application of the VoIP terminal.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a VoIP terminal according to the invention;

FIG. 2 is a flowchart illustrating a packet reception process by the VoIP terminal according to the invention;

FIG. 3 is a flowchart illustrating a packet transmission process by the VoIP terminal according to the invention; and

FIG. 4 is a table illustrating a communication stack structure of the VoIP terminal according to the invention.

### DETAILED DESCRIPTION OF THE PREFERRED EMBODIMENTS

The following detailed description will present a VoIP terminal and its communication process according to the invention with reference to the accompanying drawings.

Herein it should be also construed that the same reference signs are used to designate the same or similar components throughout different drawings for the sake of understanding.

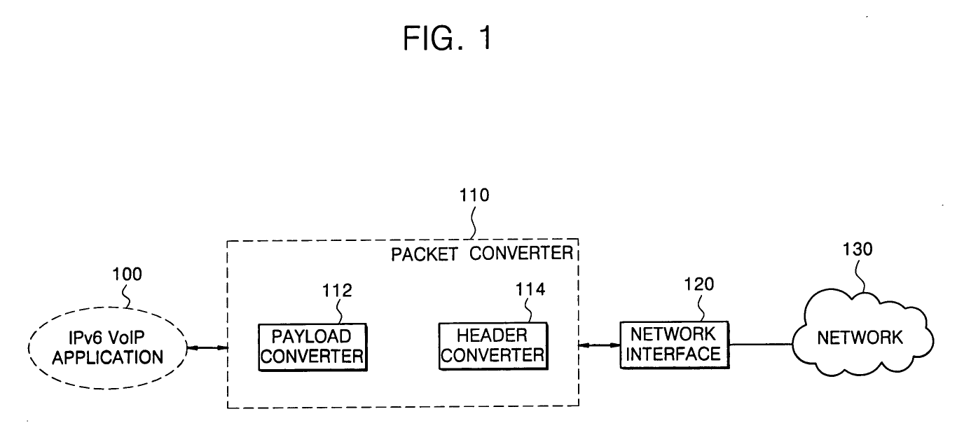

FIG. 1 is a block diagram of a VoIP terminal according to the invention.

As shown in FIG. 1, the VoIP terminal of the invention includes a packet converter 110 and a network interface 120, in which only a VoIP application for IPv6 (hereinafter will be referred to as “IPv6 VoIP application”) is executed in the VoIP terminal.

FIG. 4 illustrates a communication stack structure of the VoIP terminal according to the invention which executes the IPv6 VoIP application.

As shown in FIG. 4, the communication stack structure of the VoIP terminal according to the invention includes an IPv4 stack and an IPv6 stack, and executes only the IPv6 VoIP application.

A packet converter in the communication stack structure of FIG. 4 of the VoIP terminal executes the same function and operation as the packet converter 110 shown in FIG. 1, and is located between an IPv6 socket and a TCP/UDP (Transmission Control Protocol/User Datagram Protocol).

In addition, IPv4/IPv6 stacks shown in FIG. 4 may correspond to the network interface 120 shown in FIG. 1.

The operation of the packet converter 110 will now be described.

The packet converter 110 converts the format of a packet transmitted/received between an IPv6 VoIP application 100 and a counterpart VoIP terminal (not shown) connected to a network 130 so as to enable mutual communication.

The counterpart VoIP terminal connected to the network 130 maybe an IPv4-based VoIP terminal or an IPv6-based VoIP terminal according to the address system of the network 130.

This will be described in more detail.

The packet converter 110 includes a payload converter 112 and a header converter 114. If the IPv6 VoIP application 100 requests transmission of an IPv6 VoIP packet to the IPv4-based VoIP terminal, the packet converter 110 converts the IPv6 VoIP packet into an IPv4 VoIP format and provides an IPv4 VoIP packet to the network interface 120.

The header of the IPv6 VoIP packet to be transmitted to the IPv4-based VoIP terminal includes an IPv4-based VoIP terminal address (destination address) and an IPv6-based VoIP terminal address (source address) where the IPv6 VoIP application 100 runs.

The payload of the IPv6 VoIP packet, which is to be transmitted to the IPv4-based VoIP terminal, includes the IPv6-based VoIP terminal address (source address) where the IPv6 VoIP application 100 runs.

The payload includes the IPv6-based VoIP terminal address (source address) where the IPv6 VoIP application 100 runs because the IPv4-based counterpart VoIP terminal uses the address information included in the payload when sending an acknowledgment message to the IPv6-based VoIP terminal.

That is, the header converter 114 serves to convert the format of the IPv6-based VoIP terminal address (source address) included in the IPv6 VoIP packet header, which is to be transmitted to the IPv4-based VoIP terminal, into an IPv4-based VoIP terminal address (source address).

The payload converter 112 also converts the format of the IPv6-based VoIP terminal address (source address) included in the payload of the IPv6 VoIP packet, which is to be transmitted to the IPv4-based VoIP terminal, into the IPv4-based VoIP terminal address (source address).

Then, the packet converter 110 transmits the format-converted IPv4 VoIP packet to the IPv4-based counterpart VoIP terminal, which is connected to the network 130, via the network interface 120.

On the other hand, in response to a request of the IPv6 VoIP application 100 to transmit the IPv6 VoIP packet to another IPv6-based VoIP terminal (destination), the packet converter 110 transmits the requested IPv6 VoIP packet to the IPv6-based VoIP terminal, which is connected to the network 130, via the network interface 120.

In case that the transmission of the IPv6 VoIP packet is requested, the packet converter 110 transmits the corresponding IPv6 VoIP packet to the destination IPv6-based VoIP terminal, which is connected to the network 130, via the network interface 120 without converting its format.

The header of the IPv6 VoIP packet to be transmitted to the destination IPv6-based VoIP terminal includes a destination IPv6-based VoIP terminal address (destination address) and a source IPv6-based VoIP terminal address (source address) where the IPv6 VoIP application 100 runs.

The payload of the IPv6 VoIP packet to be transmitted to the destination IPv6-based VoIP terminal includes the address of the source IPv6-based VoIP terminal (source address) where the IPv6 VoIP application 100 runs.

Upon receiving an IPv4 VoIP packet via the network interface 120 from the IPv4-based VoIP terminal connected to the network 130, the packet converter 110 converts the format of the IPv4 VoIP packet received via the network interface 120 into an IPv6 VoIP packet, and provides the format-converted IP VoIP packet to the VoIP application 100.

The header of the IPv4 VoIP packet transmitted from the IPv4-based VoIP terminal includes the source IPv4-based VoIP terminal address (source address) and the destination IPv6-based VoIP terminal address (destination address) where the IPv6 VoIP application 100 runs.

The payload of the IPv4 VoIP packet transmitted from the IPv4-based VoIP terminal includes the source IPv4-based VoIP terminal address (source address).

That is, the header converter 114 converts the format of the source IPv4-based VoIP terminal address (source address), which is included in the IPv4 VoIP packet header received from the IPv4-based VoIP terminal, into an IPv6-based VoIP terminal address (source address).

The payload converter 112 also converts the format of the source IPv4-based VoIP terminal address (source address), which is included in the payload of the IPv4 VoIP packet received from the IPv4-based VoIP terminal, into an IPv6-based VoIP terminal address (source address).

Then, the packet converter 110 provides the format-converted IPv6 VoIP packet to the IPv6 VoIP application 100.

On the other hand, upon receiving an IPv6 VoIP packet via the network interface 120 from a distant IPv6-based VoIP terminal connected to the network 130, the packet converter 110 provides the IPv6 VoIP packet to the IPv6 VoIP application 100.

That is, if the packet received from the distant IPv6-based VoIP terminal connected to the network 130 is an IPv6 VoIP packet, the packet converter 110 provides the corresponding IPv6 VoIP packet to the IPv6 VoIP application 100 without converting its format.

The header of the IPv6 VoIP packet transmitted from the distant IPv6-based VoIP terminal includes the source IPv6-based VoIP terminal address (source address) and the destination IPv6-based VoIP terminal address (destination address) where the IPv6 VoIP application 100 runs.

The payload of the IPv6 VoIP packet received from the distant IPv6-based VoIP terminal connected to the network 130 includes the source IPv6-based VoIP terminal address (source address) of the terminal connected to the network 130.

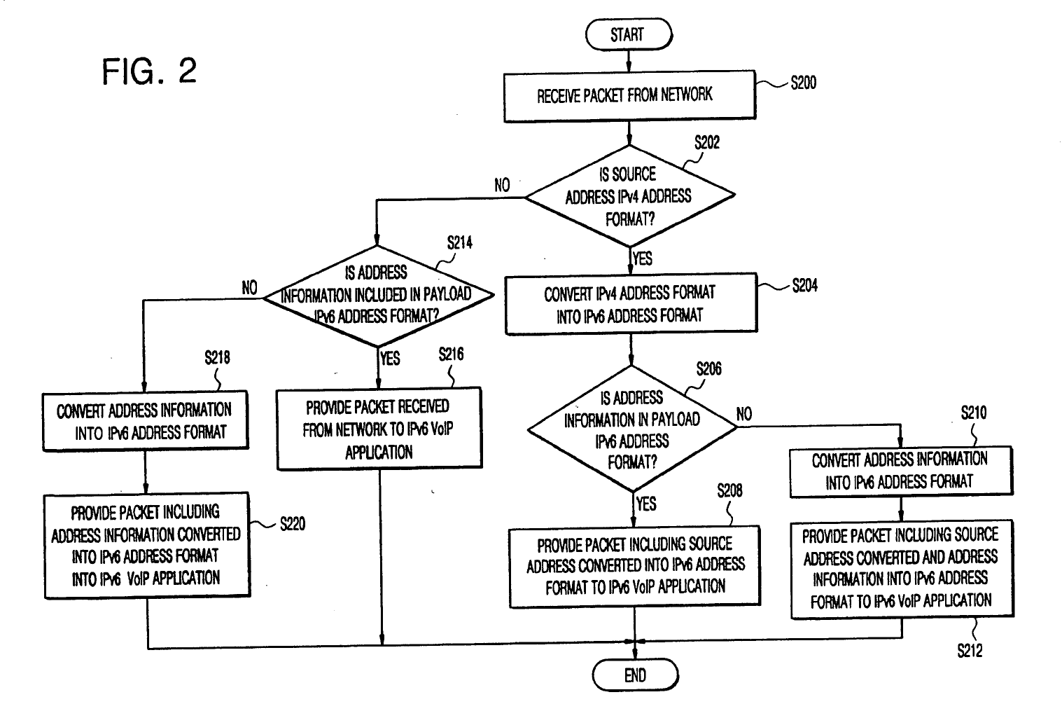

FIG. 2 is a flowchart illustrating a packet reception process by the VoIP terminal according to the invention.

The VoIP terminal of the invention preferably has a communication stack structure as shown in FIG. 4. That is, it is preferable that only an IPv6 VoIP application is run in the VoIP terminal of the invention.

As shown in FIG. 2, the IPv6 VoIP terminal receives a packet from the network in S200, and inspects the packet to find whether or not the source address of the packet header is IPv4-formatted in S202. The network may be of an IPv4 network or IPv6 network.

If the source address in the header of the packet received from the network is IPv4-formatted, the VoIP terminal converts the IPv4 format of the corresponding source address into an IPv6 format in S204.

In this case, the header and the source address of the packet received from the network can be format-converted by the header converter 114 as shown in FIG. 1.

Then, the IPv6 VoIP terminal inspects whether or not the address information included in the payload of the packet received from the network is formatted into an IPv6 address in S206.

The address information included in the payload of the packet received from the network may be any one of the address of a transmitting VoIP terminal, which has transmitted the packet to the network, and the address of at least one receiving VoIP terminal, which will receive an acknowledgment message from the VoIP terminal in response to the packet received from the network, in which the receiving VoIP terminals do not include the transmitting VoIP terminal.

If the address information included in the payload is converted into an IPv6 address format, the VoIP terminal provides the packet including the source address converted into the IPv6 address format to the IPv6 VoIP application in S208.

On the other hand, if the address information included in the payload is not converted into an IPv6 address format, the VoIP terminal converts the address information into an IPv6 address format in S210.

In this case, the format of the address information included in the payload may be converted into the IPv6 address format by the payload converter 112 as shown in FIG. 1.

The format conversion of the address information included in the payload maybe executed by using an address conversion table including an IPv6 address corresponding to at least one IPv4 address and an IPv4-mapped IPv6 address.

In S212, the VoIP terminal provides a packet including a source address converted and address information into an IPv6 address format to the IPv6 VoIP application that is running.

In S214, if the source address included in the header of the packet received from the network in S202 is not an IPv4 address format, the VoIP terminal inspects whether or not the address information in the payload of the packet received from the network is an IPv6 address format.

If the address information in the payload of the packet received from the network is the IPv6 address format, the VoIP terminal provides the packet received from the network to the IPv6 VoIP application.

On the other hand, if the address information in the payload of the packet received from the network is not the IPv6 address format, the VoIP terminal converts the corresponding address information into an IPv6 address format in S218.

In S220, the VoIP terminal provides the packet including the address information, which is converted into the IPv6 address format, to the IPv6 VoIP application.

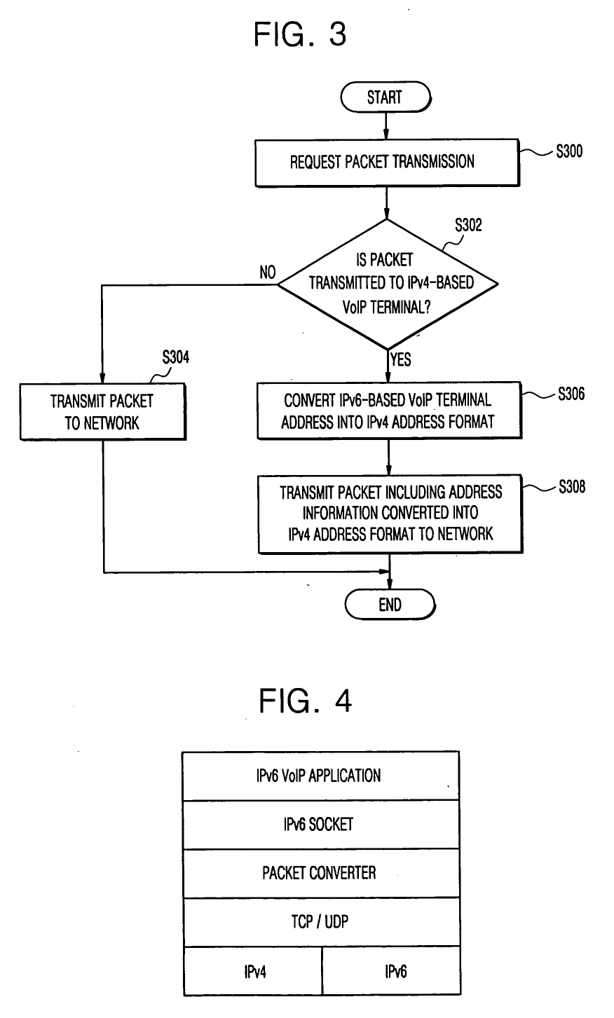

FIG. 3 is a flowchart illustrating a packet transmission process by the VoIP terminal according to the invention.

The VoIP terminal of the invention preferably has a communication stack structure as shown in FIG. 4. That is, it is preferable that only an IPv6 VoIP application is run in the VoIP terminal of the invention.

As shown in FIG. 3, in case that the running IPv6 VoIP application sends a packet transmission request to the VoIP terminal in S300, the VoIP terminal inspects whether or not the destination of the packet is an IPv4-based VoIP terminal in S302.

The header of the packet to be transmitted to a distant VoIP terminal includes the address of the destination VoIP terminal (destination address) and the address of the source IPv6-based VoIP terminal (source address) which has generated the packet.

The payload of the packet to be transmitted to the distant VoIP terminal includes the address of the source IPv6-based VoIP terminal (source address) which has generated the packet.

That is, it can be judged whether or not the packet is to be transmitted to an IPv4-based VoIP terminal by inspecting the format of the destination address included in the header of the packet.

If the destination of the packet is the IPv4-based VoIP terminal, the VoIP terminal converts the header of the packet and the IPv6-based VoIP terminal address (source address) of the packet into an IPv4 address format in S306.

Then, the VoIP terminal transmits the address information converted into the IPv4 address format on the packet to the network in S308. The network to which the packet including the VoIP terminal address of the IPv4 address format may be an IPv4 or IPv6 network.

If it is determined in S302 that the destination of the packet is an IPv6-based VoIP terminal, the VoIP terminal transmits the packet to the network in S304 without format conversion. The network to which the IPv6 VoIP packet is transmitted may be an IPv4 or IPv6 network.

According to the VoIP terminal and the communication method thereof of the invention described above, communication can be carried out with an IPv4 or IPv6 based VoIP terminal irrespective of VoIP protocols.

Furthermore, according to the VoIP terminal and the communication method thereof of the invention, it is possible to carry out communication with IPv4- and IPv6-based VoIP terminals by using only an IPv6 VoIP application in an IPv4/IPv6 dual stack. This as a result can save cost owing to reduction in necessary memory as well as simplify database installation and operation.

While the present invention has been shown and described in connection with the preferred embodiments, it will be apparent to those skilled in the art that modifications and variations can be made without departing from the spirit and scope of the invention as defined by the appended claims.

What is claimed is:

1. A Voice over Internet Protocol (VoIP) terminal that communicates with at least one other terminal by using at least one VoIP application based upon a predetermined address format, comprising a message format converter and a network interface for transmitting a VoIP packet to said receiving terminal via a network, the message format converter carrying out steps of:
a) converting a first address information into an address format of a receiving terminal, the first address information allowing said VoIP application to communicate with the receiving terminal, and transmitting a first message including the format-converted first address information to the receiving terminal; and
b) converting a second address information included in a second message received from a transmitting terminal into the predetermined address format, and providing the second message including the format-converted second address information to said VoIP application of the VoIP terminal.

2. The VoIP terminal according to claim 1, wherein the predetermined address format is an IPv6 address format.

3. The VoIP terminal according to claim 1, wherein the first address information includes at least one of an address of the VoIP terminal and an address of the receiving terminal.

4. The VoIP terminal according to claim 3, wherein the address of the VoIP terminal is an IPv6 address format and the address of the receiving terminal is an IPv4 address format or an IPv6 address format.

5. The VoIP terminal according to claim 1, wherein the second address information includes at least one of an address of the VoIP terminal and an address of the transmitting terminal.

6. The VoIP terminal according to claim 5, wherein the address of the transmitting terminal is an IPv4 address format or an IPv6 address format.

7. A Voice over Internet Protocol (VoIP) terminal that communicates with at least one other terminal of a different address format by using at least one VoIP application based upon a predetermined address format, comprising:
a header address converter for converting a first address information, which will be included in a first message to be transmitted from the VoIP application to a receiving terminal, into an address format of the receiving terminal, and converting a second address information included in a header of a second message received from a transmitting terminal into the predetermined address format to provide the format-converted second address information to the VoIP application of the VoIP terminal; and
a payload address converter for converting an address information included in a payload of the first message into the address format of the receiving terminal, and converting an address information included in a payload of the second message into the predetermined address format to provide the format-converted address information in the payload of the second message to the VoIP application of the VoIP terminal.

8. A message transmission method in a Voice over Internet Protocol (VoIP) terminal that communicates with at least one terminal of a different address format by using at least one application based upon a predetermined address format, the method comprising steps of:
converting an address information into an address format of a receiving terminal, the address information allowing said least one application of the VoIP terminal to communicate with the receiving terminal; and
transmitting a message including the format-converted address information to the receiving terminal.

9. The message transmission method according to claim 8, wherein the predetermined address format is an IPv6 address format.

10. The message transmission method according to claim 8, wherein the address information includes at least one of an address of the VoIP terminal and an address of the receiving terminal.

11. The message transmission method according to claim 10, wherein the address of the transmitting terminal is an IPv4 address format or an IPv6 address format.

12. A message receiving method in a Voice over Internet Protocol (VoIP) terminal that communicates with at least one terminal of a different address format by using at least one application based upon a predetermined address format, the method comprising steps of:
converting an address information included in a message received from a transmitting terminal into the predetermined address format; and
providing the message including the format-converted address information to said at least one application of the VoIP terminal.

13. The message receiving method according to claim 12, wherein the predetermined address format is an IPv6 address format.

14. The message receiving method according to claim 12, wherein the address information includes at least one of an address of the VoIP terminal and an address of the transmitting terminal.

15. The message receiving method according to claim 14, wherein the address of the VoIP terminal is an IPv6 address format and the address of the transmitting terminal is an IPv4 address format or an IPv6 address format.
